(19) United States
(12) Patent Application Publication
(10) Pub. No.: US 2017/0306451 A1
(43) Pub. Date: Oct. 26, 2017

(54) THREE PHASE BOND COAT COATING SYSTEM FOR SUPERALLOYS

(71) Applicant: GENERAL ELECTRIC COMPANY, Schenectady, NY (US)

(72) Inventors: Voramon Supatarawanich DHEERADHADA, Latham, NY (US); Don Mark LIPKIN, Niskayuna, NY (US); Akane SUZUKI, Clifton Park, NY (US)

(73) Assignee: GENERAL ELECTRIC COMPANY, Schenectady, NY (US)

(21) Appl. No.: 15/138,286

(22) Filed: Apr. 26, 2016

(51) Int. Cl. C22C 19/05; B32B 15/01; B32B 15/04

(52) U.S. Cl. CPC C22C 19/058; B32B 15/043; B32B 15/01; B32B 2603/00

(57) ABSTRACT

Provided is a nickel-based coating composition containing cobalt, chromium, aluminum, tantalum, and nickel. The coating composition has a three phase γ, γ′, β microstructure wherein at least 5 volume % of the coating composition is present in the β phase. Also provided are coating systems containing the coating composition, articles having the coating composition or coating system, and methods for protecting nickel-based superalloy substrates using the coating composition or coating system.

### BACKGROUND

The invention includes embodiments that relate to a coating composition and coating system for superalloys. More particularly, the invention includes embodiments that relate to a coating system employing a nickel-based three phase γ, γ′, β coating composition on a nickel-based superalloy substrate.

Superalloy components are commonly used in various applications, including, for example, in aircraft engine, gas turbine, and marine turbine industries. Generally, the quality of the superalloy components is imperative to their successful function, which can involve operation in hostile thermal environments (e.g., in a gas turbine engine). Thus, certain superalloy components that are susceptible to damage are optionally protected by one or more coatings (such as, for example, a bond coat) that serve to help to maintain the quality of the superalloy component. However, to date, coating systems employing bond coats often suffer from less than desirable attributes, for example, substrate compatibility and thermal barrier coating (TBC) spallation life. Thus, a need exists for an improved coating system that allows for improved overall superalloy component performance.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### BRIEF DESCRIPTION

Briefly, embodiments of the present invention satisfy the need for an improved overall TBC-bond coat-substrate performance.

More particularly, embodiments of the invention provide a coating composition and a coating system employing the coating composition, which is protective of a nickel-based superalloy substrate which may be used in, for example, a hostile thermal environment (e.g., turbine, combustor, and augmentor components of a gas turbine engine).

Embodiments of the present invention may address one or more of the problems and deficiencies of the art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

Certain embodiments of the presently-disclosed coating compositions, coating systems, and methods have several features, no single one of which is solely responsible for their desirable attributes. Without limiting the scope of the coating compositions, coating systems, and methods as defined by the claims that follow, their more prominent features will now be discussed briefly. After considering this discussion, and particularly after reading the section of this specification entitled “Detailed Description” one will understand how the features of the various embodiments disclosed herein provide a number of advantages over the current state of the art. These advantages may include, without limitation, providing improved coating compositions, and coating systems, and providing improved articles that may benefit from, inter alfa, improved cyclic oxidation life or thermal barrier coating (TBC) spallation performance (as defined by exposure length until spallation or detachment of TBC occurs).

In one aspect, the invention provides a nickel-based metallic coating composition comprising:

2-12 wt % cobalt;

4-8 wt % chromium;

8-25 wt % aluminum;

5-10 wt % tantalum; and

35-81 wt % nickel,

said coating composition comprising a three phase γ, γ′, β microstructure wherein at least 5 volume % of the coating composition is present in the β phase,and a remainder is present in the γ and γ′ phases.

In a second aspect, the invention provides a coating system on a substrate comprising:

a nickel-based superalloy substrate; and

a nickel-based metallic coating composition disposed on the substrate, the coating composition comprising:
2-12 wt % cobalt;
4-8 wt % chromium;
8-25 wt % aluminum;
5-10 wt % tantalum; and
35-81 wt % nickel,

said coating composition comprising a three phase γ, γ′, β microstructure wherein at least 5 volume % of the coating composition is present in the β phase, and a remainder is present in the γ and γ′ phases.

In a third aspect, the invention provides a method for improving the cyclic oxidation life or TBC spallation performance of an article comprising a nickel-based superalloy substrate, the method comprising coating at least a portion of the substrate with a nickel-based me1tallic coating composition comprising:
2-12 wt % cobat;
4-8 wt % chromiu;
8-25 wt % aluminum;
5-10 wt % tantalum; and
35-81 wt % nickel,
   said coating composition comprising a three phase γ, γ′, β microstructure wherein at least 5 volume % of the coating composition is present in the β phase, and a remainder is present in the γ and γ′ phases.

These and other features and advantages of this invention will become apparent from the following detailed description of the various aspects of the invention taken in conjunction with the appended claims and the accompanying drawings.

### DRAWINGS

FIG. 1 is a perspective view of a high pressure turbine blade.

FIG. 2 shows a coating system in accordance with an embodiment of the invention.

FIG. 3 is cross-sectional view of a portion of the blade of FIG. 1 along line 2-2 and shows a coating system in accordance with an embodiment of the invention.

FIG. 4 is a chart showing the results of FCT cycle testing of coating systems according to embodiments of the invention.

FIG. 5 is a chart showing a true CTE over temperature ranges between 100-1300° C. for an embodimeent of the invention (BC5X), and for comparative examples N5 substrate, and β-NiAl bond coat.

### DETAILED DESCRIPTION

Embodiments of the present invention are generally directed to a coating composition, to a coating system comprising coating composition on a nickel-based superalloy substrate, and to methods relating to the coating composition and coating system.

Although this invention is susceptible to embodiment in many different forms, certain embodiments of the invention are shown and described. It should be understood, however, that the present disclosure is to be considered as an exemplification of the principles of this invention and is not intended to limit the invention to the embodiments illustrated.

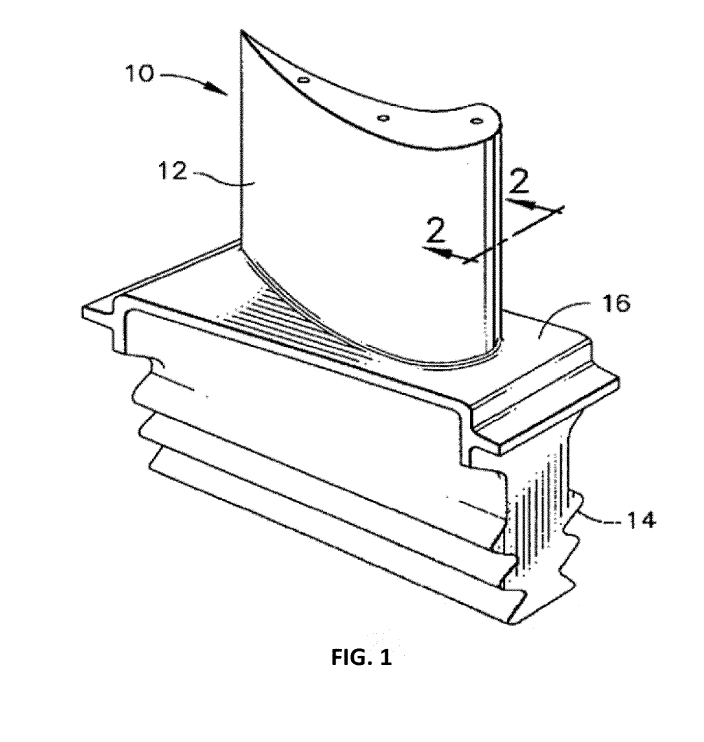

Embodiments of the inventive coating compositions and coating systems are useful, for example, for protecting components that operate within environments characterized by relatively high temperatures, and may therefore be subjected to severe thermal stresses and thermal cycling. Notable non-limiting examples of such components include the high and low pressure turbine nozzles and blades, shrouds, combustor liners and augmentor hardware of gas turbine engines. One such example is the high pressure turbine blade 10 shown in FIG. 1. The blade 10 generally includes an airfoil 12 against which hot combustion gases are directed during operation of the gas turbine engine, and whose surface is therefore subjected to severe attack by oxidation, corrosion and erosion. The airfoil 12 is anchored to a turbine disk (not shown) with a dovetail 14 formed on a root section 16 of the blade 10. Although embodiments and advantages of the invention may be described with reference to the high pressure turbine blade 10 shown in FIG. 1, the teachings of this invention are generally applicable to any Ni-based component on which a coating system may be used to protect the component from its environment.

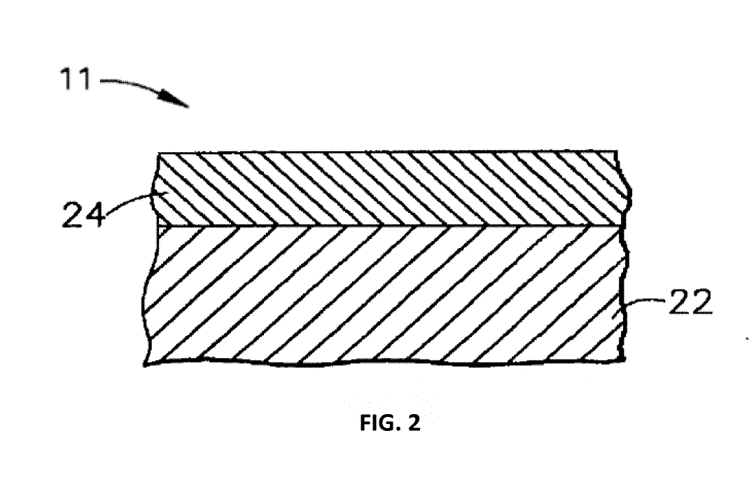

FIG. 2 depicts a coating system 11 in accordance with an embodiment of the invention. Coating system 11 comprises a nickel-based superalloy substrate 22 (which, in the depicted embodiment, is the blade 10 depicted in FIG. 1), and a coating composition 24.

The coating composition 24 is a nickel-based metallic coating composition comprising:
2-12 wt % cobalt (Co);
4-8 wt % chromium (Cr);
8-25 wt % aluminum (Al);
5-10 wt % tantalum (Ta); and
35-81 wt % nickel (Ni),
   said coating composition comprising a three phase γ (Ni), γ′ (e.g., Ni₃Al), β (e.g., NiAl) microstructure wherein at least 5 volume % of the coating composition is present in the β phase, and a remainder is present in the γ and γ′ phases.

As discussed above, the coating composition 24 comprises:
2-12 wt % cobalt (e.g., 2, 3, 4, 5, 6, 7, 8, 9, 10, 11, or 12 wt %), including any and all ranges and subranges therein (e.g., 9-11 wt %, 7-8 wt %, etc.);
4-8 wt % chromium (e.g., 4, 5, 6, 7, or 8 wt %), including any and all ranges and subranges therein (e.g., 5-7 wt %);
8-25 wt % aluminum (e.g., 8, 9, 10, 11, 12, 13, 14, 15, 16, 17, 18, 19, 20, 21, 22, 23, 24, or 25 wt %), including any and all ranges and subranges therein (e.g., 9-16 wt %);
5-10 wt % tantalum (e.g., 5, 6, 7, 8, 9, or 10 wt %), including any and all ranges and subranges therein (e.g., 5-7 wt %); and
35-81 wt % nickel (e.g., 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, or 81 wt %), including any and all ranges and subranges therein (e.g., 54-72 wt %).

In some embodiments, the coating composition 24 comprises 9-11 wt % cobalt; 5-7 wt % chromium; 9-16 wt % aluminum; 5-8 wt % tantalum; and 54-72 wt % nickel.

The coating composition 24 comprises a three phase γ, γ′, β microstructure wherein at least 5 volume % of the coating composition is present in the β phase, and a remainder is present in the γ and γ′ phases. In other words, the coating composition 24 has a microstructure that includes at least γ, γ′, and β (at least 5 vol %) phase superalloy. In some embodiments, one or more additional phases (e.g., carbide phase) may be present in the microstructure of coating composition 24. In some embodiments, at least 95% of the microstructure of coating composition 24 consists of γ, γ′ and β phase. In some embodiments, at least 98% of the microstructure of coating composition 24 consists of γ, y′, and β phase. In some embodiments, the microstructure of coating composition 24 consists of γ, γ′, and β phase superalloy.

In some embodiments, 5-60 volume % (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 vol. %) of the coating composition 24 is present in the β (beta) phase (e.g., NiAl), including any and all ranges and subranges therein (e.g., 20-45 vol %).

In some embodiments, coating composition 24 comprises a three phase γ, γ′, β microstructure wherein:
5-35 volume % (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 vol. %) of the coating composition is present in the γ (gamma) phase (e.g., Ni), including any and all ranges and subranges therein (e.g., 5-30 vol %);
25-70 volume % (e.g., 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 vol. %) of the coating composition is present in the γ′ (gamma-prime) phase (e.g., Ni₃Al), including any and all ranges and subranges therein (e.g., 30-50 vol. %); and
5-60 volume % (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 vol. %) of the coating composition is present in the β (beta) phase (e.g., NiAl), including any and all ranges and subranges therein (e.g., 20-45 vol %).

In some embodiments, the coating composition 24 comprises a microstructure wherein: 5-30 volume % of the coating composition 24 is present in the γ phase; 30-50 volume % of the coating composition 24 is present in the γ′ phase; and 20-45 volume % of the coating composition 24 is present in the β phase.

In some embodiments, the coating composition 24 comprises 0.01 to 2 wt % (e.g., 0.01, 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 wt %) of hafnium, silicon, zirconium, or a combination thereof, including any and all ranges and subranges therein.

The platinum group metals (PGMs) are six transitional metal elements (iridium (Ir), osmium (Os), palladium (Pd), platinum (Pt), rhodium (Rh), ruthenium (Ru)) that are chemically, physically and anatomically similar. While some embodiments of the inventive coating composition 24 comprise one or more PGMs, Applicant has unexpectedly found that inventive compositions are capable of improved protection (e.g., improved cyclic oxidation life or TBC spallation performance) even when PGMs are omitted. Accordingly, in some embodiments, the coating composition 24 does not comprise a platinum group metal.

In some embodiments, the coating composition comprises 24 platinum. For example, in some embodiments, the coating composition 24 comprises 0.1 to 15 wt % (e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, or 15.0 wt %) platinum, including any and all ranges and subranges therein. In other embodiments, the coating composition 24 does not comprise platinum.

In some embodiments, the coating system 11 comprises one or more PGMs. In other embodiments, the coating system 11 does not comprise a PGM.

In some embodiments, the coating system 11 comprises platinum. In other embodiments, the coating system 11 does not comprise platinum.

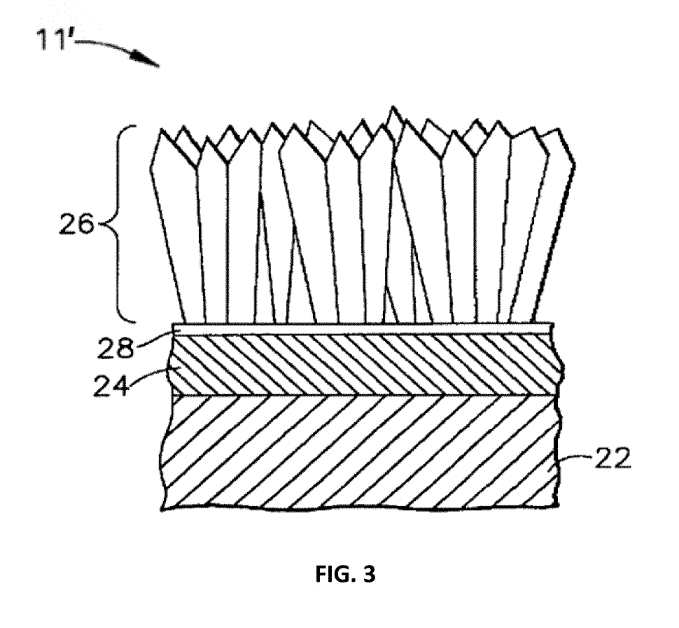

In various embodiments, coating composition 24 serves to environmentally protect the substrate 22 when exposed to an oxidizing environment, and to provide a reservoir of aluminum from which, as depicted in FIG. 3, an aluminum oxide surface layer (alumina scale) 28 grows to promote adhesion of the TBC 26. Coating composition 24 can be deposited in any art-acceptable manner. Persons having ordinary skill in the art will appreciate that desired manners of deposition/formation may vary depending on the composition of the coating composition 24. For example, in some embodiments, the coating composition 24 is applied using a single step or multiple step deposition process, with or without a subsequent heat treatment.

In some embodiments of the invention, coating composition 24 can be formed (deposited) by methods generally used in the art, for example, plasma spray, chemical vapor deposition, cathodic arc deposition, high velocity spray, thermal spray, or any other process used by those in the art.

In some embodiments, after forming, coating composition 24 is subsequently heat treated at 1800-2200° F. to achieve the 3-phase γ, γ′, β microstructure.

In some embodiments, the coating composition 24 has an average thickness of 10 to about 500 μm (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm), including any and all ranges and subranges therein. Such embodiments are found to sufficiently protect the underlying substrate 22 and provide, where desired, an adequate supply of aluminum for formation of the alumina scale 28.

In some embodiments, the coating composition 24 has an average thickness of about 15 to about 400 microns.

In some embodiments, the coating composition 24 has an average thickness of about 20 to about 50 microns.

In some embodiments, specific elements such as chromium (Cr) and tantalum (Ta) in coating composition 24 are optimized to match chemical potential in specific nickel-based superalloy substrate 22. This is done to minimize the diffusion of particular elements (e.g. Cr or Ta) between the coating composition 24 and nickel-based superalloy substrate 22.

Aluminum is one of the main contributors to oxidation and corrosion resistance of the coating composition 24. The formation of aluminum oxide (Al₂O₃) provides oxidation and corrosion resistance to coating composition 24 and nickel-based superalloy substrate 22 from further exposure to harsh environment. Therefore, various embodiments of the invention optimize aluminum content in the coating composition 24. In some embodiments of coating composition 24, aluminum content is maximized in the coating composition 24 while maintaining 3 phase γ, γ′, R microstructure with desired γ, γ′, β volume fraction.

In various embodiments, concentrations of each element in coating composition 24 are carefully designed to maximize oxidation and corrosion resistance (e.g. aluminum or cobalt content) and minimize interdiffusion between coating composition 24 and nickel-based superalloy substrate 22.

The presence of all three phases (γ, γ′, β) in the microstructure of coating composition 24 optimizes resistance to environmental (e.g. oxidation and corrosion) attack as well as resistance to thermal cycling (e.g. TBC spallation life). The presence of and (to certain extent) γ′ phase in the coating composition 24 improves oxidation and corrosion resistance of the coating. Whereas γ and γ′ phase in the coating composition 24 improves microstructure stability and compatibility to the nickel-based superalloy substrate 22.

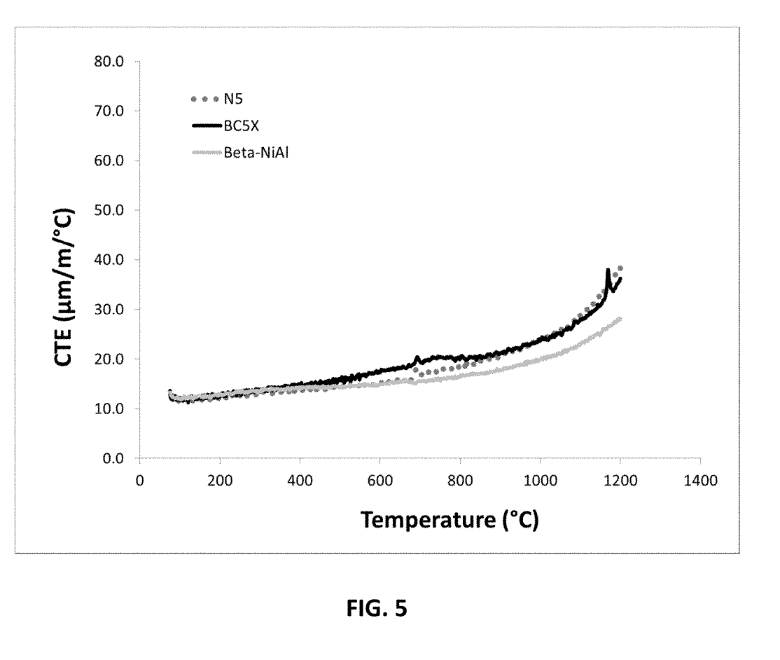

The bond coat with three phase γ, γ′, β microstructure results in a reduction of the thermal expansion coefficient (CTE) mismatch between substrate and bond coat. FIG. 5 is a chart showing a true CTE over temperature ranges between 100-1300° C. for an embodiment of the invention (BC5X, details below), N5 substrate, and singe phase β-NiAl (platinum-free) bond coat. The better compatibility with the substrate and higher strength of the BC5X exemplary embodiment bond coat results in less rumpling in bond coat during exposure and improve adhesion at oxide/TBC interface, thereby, increasing its resistance to thermal cycles.

The nickel-based superalloy substrate 22 of coating system 11 may be of any nickel-based superalloy subcomponent composition for which the benefits afforded by embodiments of the inventive coating composition and system are desired. Selection of such substrates is within the purview of a person having ordinary skill in the art.

In some embodiments, the nickel-based superalloy substrate 22 comprises a material selected from a single crystal superalloy, a directionally solidified superalloy, and a polycrystalline superalloy.

As used herein, a “single crystal superalloy” includes an alloy formed as a single crystal, such that there are generally no high angle grain boundaries in the material.

As used herein, a “directionally solidified superalloy” includes an alloy having a columnar grain structure where grain boundaries created in the solidification process are aligned parallel to the growth direction.

As used herein, a “polycrystalline superalloy” includes an alloy having a randomly oriented equiaxed grain structure including powder processing alloys.

In some embodiments, the nickel-based superalloy substrate 22 comprises a majority of nickel. For example, in some embodiments, the nickel-based superalloy substrate 22 comprises 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 wt % nickel, including any and all ranges and subranges therein (e.g., 50-80 wt %, etc.).

In some embodiments, the nickel-based superalloy substrate 22 comprises, in addition to nickel, one or more elements selected from cobalt, chromium, molybdenum, tungsten, rhenium, aluminum, tantalum, hafnium, niobium, titanium, ruthenium, carbon, boron silicon, and zirconium.

In some embodiments, the nickel-based superalloy substrate 22 comprises:
3-20 wt % cobalt (e.g., 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, or 20.0 wt %), including any and all ranges and subranges therein (e.g., 3-17 wt %, 5-15 wt %, 7-8 wt %, 8-11 wt %);
2-22 wt % chromium (e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9, 20.0, 20.1, 20.2, 20.3, 20.4, 20.5, 20.6, 20.7, 20.8, 20.9, 21.0, 21.1, 21.2, 21.3, 21.4, 21.5, 21.6, 21.7, 21.8, 21.9, or 22.0 wt %), including any and all ranges and subranges therein (e.g., 2-14 wt %, 5-10 wt %, 6.5-7.5 wt %);
0-4 wt % molybdenum (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 wt %), including any and all ranges and subranges therein (e.g., 0-3 wt %, 0.5-2.5 wt %, 1-2 wt %);
0-10 wt % tungsten (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 wt %), including any and all ranges and subranges therein (e.g., 3-10 wt %, 4-8 wt %, 4.5-5.5 wt %);
0-6 wt % rhenium (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, or 6.0 wt %), including any and all ranges and subranges therein (e.g., 0.1-5.5 wt %, 2-4 wt %, 2.5-3.5 wt %);
2-8 wt % aluminum (e.g., 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, or 8.0 wt %), including any and all ranges and subranges therein (e.g., 4-8 wt %, 6-7 wt %);
0-10 wt % tantalum (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 wt %), including any and all ranges and subranges therein (e.g., 3-10 wt %, 6-7 wt %);
0-2 wt % hafnium (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2.0 wt %), including any and all ranges and subranges therein (e.g., 0-1.7 wt %, 0.1-0.6 wt %);
0-5 wt % niobium (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt %), including any and all ranges and subranges therein (e.g., 0-1 wt %);
0-4 wt % titanium (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 wt %), including any and all ranges and subranges therein (e.g., 0-3.5 wt %);
0-5 wt % ruthenium (e.g., 0.0, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 wt %), including any and all ranges and subranges therein (e.g., 0-4.5 wt %); and
a remainder of nickel.

In some embodiments, the inventive coating system 11 additionally comprises one or more further layers. For example, FIG. 3 depicts a cross-sectional view of a portion of the blade of FIG. 1 along line 2-2 and shows a coating system 11′ in accordance with an embodiment of the invention. The coating system 11′ comprises, in addition to nickel-based superalloy substrate 22 and coating composition 24, thermal barrier coating (TBC) 26, and optionally an aluminum oxide surface layer 28. In FIG. 3, a ceramic layer (TBC) 26 is bonded to the blade substrate 22 with a coating composition 24, which serves, in the depicted embodiment, as a bond coat to the TBC 26.

The TBC 26, where present, may deposited in any art-acceptable manner. For example, in some embodiments it is deposited via a thermal spray process or physical vapor deposition (PVD), such as electron beam physical vapor deposition (EBPVD). In various embodiments, the TBC 26 comprises a ceramic material, for example, yttria-stabilized zirconia (YSZ) (e.g., a material comprising about 3 to about 20 weight percent yttria (3-20% YSZ)). In some embodiments, the TBC 26 comprises yttria, nonstabilized zirconia, and/or zirconia stabilized by other oxides. Notable alternative materials for the TBC 26 include those formulated to have lower coefficients of thermal conductivity (low-k) than 7% YSZ, notable examples of which are disclosed in commonly-assigned U.S. Pat. No. 6,586,115 to Rigney et al., U.S. Pat. No. 6,686,060 to Bruce et al., U.S. Pat. No. 6,808,799 to Darolia et al., U.S. Pat. No. 6,890,668 to Bruce et al., and U.S. Pat. No. 7,060,365 to Bruce, and in U.S. Pat. No. 6,025,078 to Rickerby. Still other suitable ceramic materials for the TBC 26 include those that resist spallation from contamination by compounds such as CMAS (a eutectic of calcia, magnesia, alumina and silica). For example, the TBC 26 can be formed of a material capable of interacting with molten CMAS to form a compound with a melting temperature that is significantly higher than CMAS, so that the reaction product of CMAS and the material does not melt and infiltrate the TBC. Examples of CMAS-resistant coatings include alumina, alumina-containing YSZ, and hafnia-based ceramics disclosed in commonly-assigned U.S. Pat. Nos. 5,660,885, 5,683,825, 5,871,820, 5,914,189, 6,627,323, 6,720,038 and 6,890,668, whose disclosures regarding CMAS-resistant coating materials are incorporated herein by reference. Other potential ceramic materials for the TBC include those formulated to have erosion and/or impact resistance better than 7% YSZ. Examples of such materials include certain of the above-noted CMAS-resistant materials, particularly alumina as reported in U.S. Pat. Nos. 5,683,825 and 6,720,038. Other erosion and impact-resistant compositions include reduced-porosity YSZ as disclosed in commonly-assigned U.S. Pat. No. 6,982,126 and commonly-assigned U.S. patent application Ser. No. 10/708,020, fully stabilized zirconia (e.g., more than 17% YSZ) as disclosed in commonly-assigned U.S. patent application Ser. No. 10/708,020, and chemically-modified zirconia-based ceramics. The TBC 26 is deposited to a thickness that is sufficient to provide the required thermal protection for the underlying substrate 22 and blade 10. For example, in some embodiments, TBC 26 has a thickness on the order of about 75 to 300 μm (e.g., 75, 80, 90, 100, 110, 120, 130, 140, 150, 160, 170, 180, 190, 200, 210, 220, 230, 240, 250, 260, 270, 280, 290, or 300 μm), including any and all ranges and subranges therein).

In one aspect, the invention provides an article comprising the coating composition or coating system discussed above.

In some embodiments, (e.g., the turbine blade 10 of FIG. 1), the article is a gas turbine component.

In another aspect, the invention provides methods of protecting a nickel-based superalloy substrate, the method comprising coating at least a portion of the substrate with the coating composition 24 discussed above.

In some embodiments, the invention provides a method for improving cyclic oxidation life or TBC spallation performance of an article comprising a nickel-based superalloy substrate, the method comprising coating at least a portion of the substrate with a nickel-based metallic coating composition 24.

Several embodiments of the invention are described in the examples below.

### EXAMPLES

The coating composition of Table I was prepared on N5 superalloy substrate, thereby forming coating systems according to non-limiting embodiments of the invention.

In example 1, BC5X coating was deposited via cathodic arc deposition technique. Subsequent heat treatment was done between 1850-2000° F. to set the three phase microstructure with about 14 vol. % γ, 51 vol. % γ′, and 35 vol. %

For comparative example, the diffusion aluminide coating, β-(Ni,Pt)Al, was processed by platinum plated and aluminization according to U.S. Pat. No. 5,658,614. The comparative example is a single phase β-(Ni,Pt)Al bond coat. Its average composition (main elements only—other elements such as Co, Ta, etc. are present in the bond coat due to diffusion during coating formation process) is listed in Table I.

TABLE I

| | Ni | Co | Cr | Al | Ta | C | Hf | Zr | Y | Si | Pt |
|---|---|---|---|---|---|---|---|---|---|---|---|
| | (wt %) | (wt %) | (wt %) | (wt %) | (wt %) | (wt %) | (wt %) | (wt %) | (wt %) | (wt %) | (wt %) |
| Ex. #1 | bal | 9.1-10.3 | 5-6.6 | 10.4-15.2 | 6.1-6.4 | 0.06 | 0.3-0.5 | 0.015 | 0.3 | 1 | 0 |
| [BC5X] | | | | | | | | | | | |
| β-(Ni,Pt)Al | bal | — | 4 | 20 | — | — | — | — | — | — | 27 |

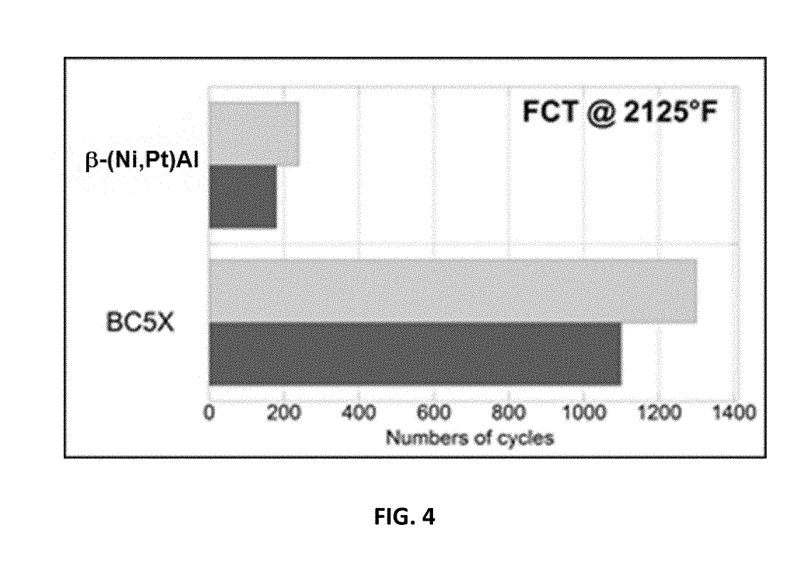

The composition of the example bond coat was subsequently coated with partially-stabilized zirconia via EB-PVD method to form a thermal barrier layer (TBC) directly on the bond coat. Subsequent furnace cycle test (FCT) was conducted at 2125° F. to evaluate durability of the coating systems on their cyclic behavior. The samples were cycled between 2125° F. and room temperature (25° F.) until significant spallation of TBC was detected. FIG. 4 is a chart showing the results of the FCT cycle testing of the BC5X coating system according to an embodiment of the invention, and the comparative single phase β-(Ni,Pt)Al coating system.

With the current state-of-the-art β-(Ni,Pt)Al coating, approximately one-fourth of the TBC spalled at around 300 cycles at 2125° F. Meanwhile, the coating of the example embodiment did not exhibit TBC spallation even after 1,000 cycles. In summary, the comparative testing demonstrates that the coating of the example embodiment provided over 3× improvement over the β-(Ni,Pt)Al current state-of-the-art coating.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or article that “comprises”, “has”, “includes” or “contains” one or more steps or elements possesses those one or more steps or elements, but is not limited to possessing only those one or more steps or elements. Likewise, a step of a method or an element of an article that “comprises”, “has”, “includes” or “contains” one or more features possesses those one or more features, but is not limited to possessing only those one or more features. Furthermore, an article or structure that is configured in a certain way is configured in at least that way, but may also be configured in ways that are not listed.

As used herein, the terms “comprising” and “including” or grammatical variants thereof are to be taken as specifying the stated features, integers, steps or components but do not preclude the addition of one or more additional features, integers, steps, components or groups thereof. This term encompasses the terms “consisting of” and “consisting essentially of”.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range as if the same were fully set forth herein.

While several aspects and embodiments of the present invention have been described and depicted herein, alternative aspects and embodiments may be affected by those skilled in the art to accomplish the same objectives. Accordingly, this disclosure and the appended claims are intended to cover all such further and alternative aspects and embodiments as fall within the true spirit and scope of the invention.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, if present, the terms “including” and “in which” are used as the plain-English equivalents of the respective terms “comprising” and “wherein.” Moreover, in the following claims, if present, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A coating system on a substrate comprising:
a nickel-based superalloy substrate; and
a nickel-based coating composition disposed on the substrate, the coating composition comprising:
2-12 wt % cobalt;
4-8 wt % chromium;
8-25 wt % aluminum;
5-10 wt % tantalum; and
35-81 wt % nickel,
said coating composition comprising a three phase γ, γ′, β microstructure wherein at least 5 volume % of the coating composition is present in the β phase and a remainder is present in the γ and γ′ phases.

2. The coating system on a substrate according to claim 1, wherein the coating composition does not comprise a platinum group metal.

3. The coating system on a substrate according to claim 1, wherein the coating composition does not comprise platinum.

4. The coating system on a substrate according to claim 1, wherein the nickel-based superalloy substrate comprises:
3-20 wt % cobalt;
2-22 wt % chromium;
0-4 wt % molybdenum;
0-10 wt % tungsten;
0-6 wt % rhenium;
2-8 wt % aluminum;
0-10 wt % tantalum;
0-2 wt % hafnium;
0-5 wt % niobium;
0-4 wt % titanium;
0-5 wt % ruthenium; and
a remainder of nickel.

5. The coating system on a substrate according to claim 4, wherein the nickel-based superalloy substrate comprises:
3-17 wt % cobalt;
2-14 wt % chromium;
0-3 wt % molybdenum;
3-10 wt % tungsten;
0-6 wt % rhenium;
4-8 wt % aluminum;
3-10 wt % tantalum;
0-2 wt % hafnium;
0-1 wt % niobium;
0-4 wt % titanium;
0-5 wt % ruthenium; and
a remainder of nickel.

6. The coating system on a substrate according to claim 1, wherein the nickel-based superalloy substrate comprises:
7-8 wt % cobalt;
6. 5-7.5 wt % chromium;
1-2 wt % molybdenum;
4.5-5.5 wt % tungsten;
2.5-3.5 wt % rhenium;
6-7 wt % aluminum;
6-7 wt % tantalum;
0.1-0.6 wt % hafnium; and
a remainder of nickel.

7. The coating system on a substrate according to claim 1, wherein:
5-35 volume % of the coating composition is present in the 65 phase;
25-70 volume % of the coating composition is present in the γ′ phase; and
5-60 volume % of the coating composition is present in the β phase.

8. The coating system on a substrate according to claim 7, wherein:
5-30 volume % of the coating composition is present in the y phase;
30-50 volume % of the coating composition is present in the γ′ phase; and
20-45 volume % of the coating composition is present in the β phase.

9. The coating system on a substrate according to claim 1, wherein the coating composition comprises 0.01 to 2 wt % of hafnium, silicon, zirconium, yttrium, or a combination thereof.

10. The coating system on a substrate according to claim 1, wherein the coating composition comprises 0.1 to 15 wt % platinum.

11. The coating system on a substrate according to claim 1, wherein the coating composition comprises:
9-11 wt % cobalt;
5-7 wt % chromium;
9-16 wt % aluminum;
5-8 wt % tantalum; and
54-72 wt % nickel.

12. The coating system on a substrate according to claim 11, wherein:
5-35 volume % of the coating composition is present in the γ phase;
25-70 volume % of the coating composition is present in the γ′ phase; and
5-60 volume % of the coating composition is present in the β phase.

13. The coating system on a substrate according to claim 11, wherein the coating composition does not comprise platinum.

14. An article comprising the coating system on a substrate according to claim 1.

15. The article according to claim 14, wherein said article is a gas turbine engine component.

16. A nickel-based coating composition comprising:
2-12 wt % cobalt;
4-8 wt % chromium;
8-25 wt % aluminum;
5-10 wt % tantalum; and
35-81 wt % nickel,
said coating composition comprising a three phase γ, γ′, β microstructure wherein at least 5 volume % of the coating composition is present in the β phase, and a remainder is present in the γ and γ′ phases.

17. The nickel-based coating composition according to claim 16, wherein the coating composition comprises:
9-11 wt % cobalt;
5-7 wt % chromium;
9-13 wt % aluminum;
5.5-8 wt % tantalum; and
54-72 wt % nickel,
and wherein:
5-35 volume % of the coating composition is present in the γ phase;
25-70 volume % of the coating composition is present in the γ′ phase; and
5-60 volume % of the coating composition is present in the β phase.

18. The nickel-based coating composition according to claim 17, wherein the coating composition does not comprise a platinum group metal.

19. An article comprising the nickel-based coating composition according to claim 18.

20. A method for improving the cyclic oxidation life or TBC spallation performance of an article comprising a nickel-based superalloy substrate, the method comprising coating at least a portion of the substrate with a nickel-based coating composition comprising:
2-12 wt % cobalt;
4-8 wt % chromium;
8-25 wt % aluminum;
5-10 wt % tantalum; and
35-81 wt % nickel,
said coating composition comprising a three phase γ, γ′, β microstructure wherein at least 5 volume % of the coating composition is present in the β phase and a remainder is present in the γ and γ′ phases.
